(19) United States
(12) Patent Application Publication
(10) Pub. No.: US 2022/0291006 A1
(43) Pub. Date: Sep. 15, 2022

(54) METHOD AND APPARATUS FOR ROUTE GUIDANCE USING AUGMENTED REALITY VIEW

(71) Applicant: NAVER LABS CORPORATION, Seongnam-si (KR)

(72) Inventors: Jeanie JUNG, Seongnam-si (KR); Yeowon YOON, Seongnam-si (KR)

(21) Appl. No.: 17/653,749

(22) Filed: Mar. 7, 2022

(30) Foreign Application Priority Data
Mar. 9, 2021 (KR) 10-2021-0030967

(51) Int. Cl. G01C 21/36; G01C 21/34

(52) U.S. Cl. CPC G01C 21/365; G01C 21/3638; G01C 21/3632; G01C 21/3602; G01C 21/3647; G01C 21/3415; G01C 21/362

(57) ABSTRACT

A route guidance method includes acquiring a route from a source to a destination and providing route guidance through an augmented reality (AR) view that includes an image captured by a camera. When providing the route guidance, as a user terminal moves toward the destination based on the acquired route, a point indicator that guides to a turn point approached by the user terminal included in the route or an instruction indicator that instructs a movement to a corresponding turn point is displayed through augmentation on an image.

### CROSS-REFERENCE TO RELATED APPLICATION(S)

This U.S. non-provisional application claims the benefit of priority under 35 U.S.C. § 119 to Korean Patent Application No. 10-2021-0030967 filed on Mar. 9, 2021, in the Korean Intellectual Property Office (KIPO), the entire contents of which are incorporated herein by reference.

### BACKGROUND OF THE INVENTION

### Field of Invention

One or more example embodiments of the invention in the following description relate to a route guidance method and apparatus using an augmented reality (AR) view, and more particularly, to technology for providing route guidance by displaying a point indicator and/or an instruction indicator as guidance information about a turn point included in a route.

### Description of Related Art

Augmented reality (AR) refers to technology that converges and supplements virtual objects and information created with computer technology in the real world. That is, AR refers to technology for augmenting and thereby displaying virtual content in the real world and a user may view the augmented content corresponding to a real environment through an electronic device.

Various services using such AR technology are developed. For example, an AR navigator that is installed in a vehicle, displays an image of a driving route captured by a camera on a display, and maps and displays virtual display information that guides a user through the driving route on the image displayed on the display is disclosed in Korean Patent Laid-Open Publication No. 10-2014-0065963, published on May 30, 2014.

### BRIEF SUMMARY OF THE INVENTION

One or more example embodiments provide a route guidance method for, when providing route guidance through an augmented reality (AR) view that includes an image captured by a camera of a user terminal, displaying a point indicator that guides a user to a corresponding turn point or an instruction indicator that instructs a movement to the corresponding turn point as guidance information about turn points included in a route depending on whether a turn point approached by the user terminal is included in the AR view or a field of view (FOV) of a camera.

One or more example embodiments may provide a route guidance method for displaying guidance information (e.g., an instruction indicator that instructs a movement to the next point) about the next point instead of displaying guidance information (e.g., an instruction indicator) about a corresponding turn point as the user terminal approaches the corresponding turn point included in a route.

According to an aspect of at least one example embodiment, there is provided a route guidance method performed by a user terminal, the route guidance method including acquiring a route from a source to a destination set by a user of the user terminal; and providing route guidance from the source to the destination through an augmented reality (AR) view that includes an image captured by a camera of the user terminal, based on the route. The route includes at least one turn point, and the providing of the route guidance includes, in response to the user terminal moving toward the destination based on the route, augmenting, on the image, and thereby selectively displaying a first point indicator that guides to a first turn point approached by the user terminal among the at least one turn point or a first instruction indicator that instructs a movement to the first turn point.

Each of the at least one turn point may be a point at which a turn of a desired angle or more is required on the route, and the first turn point may be a point to which the user terminal is to move from a current location in order to move toward the destination.

The displaying may include displaying a distance from the user terminal to the first turn point on the first point indicator.

The displaying may include displaying the first point indicator when the first turn point is included in the AR view or a field of view (FOV) of the camera.

The route guidance method may further include augmenting, on the image, displaying the first instruction indicator that instructs the movement to the first turn point through augmentation on the image without displaying the first point indicator, when the first turn point is not included in the AR view or a FOV of the camera.

The first instruction indicator may include a first element that indicates a direction from a current location of the user terminal to the first turn point and a second element that connects from the first element to the first turn point.

The first element may include an arrow that indicates the direction from the current location of the user terminal to the first turn point, and the second element may include a plurality of dots or a line that connects from the first element to the first turn point.

The displaying of the first instruction indicator may include displaying the first instruction indicator to direct to the first turn point according to rotation of the camera.

The route guidance method may further include displaying a map view that includes a map matching the image with the AR view. The map view may include the route and a current location of the user terminal, and the displaying of the first instruction indicator may include displaying the first instruction indicator at a boundary between the map view and the AR view.

In a case in which a point to which the user terminal is to move after the first turn point in order to move toward the destination among the at least one turn point is a second turn point or a destination point indicating the destination, the displaying of the first instruction indicator may include displaying all of the first instruction indicator and a second point indicator that guides to the second turn point or the destination point when the second turn point or the destination point is included in the AR view or the FOV of the camera.

The displaying of the first instruction indicator may further include displaying all of the first instruction indicator and the second point indicator when a distance from the user terminal to the first turn point is less than a distance from the user terminal to the second turn point or the destination point.

The displaying may include changing a display form of the first point indicator when a distance from the user terminal to the first turn point is a desired value or less, and the first point indicator of which the display form is changed may include guidance information about a second turn point to which the user terminal is to move after the first turn point in order to move toward the destination among the at least one turn point or a destination point indicating the destination.

The displaying may include displaying a second instruction indicator that instructs a movement to the second turn point or the destination point through augmentation on the image, and the displaying of the second instruction indicator may include displaying all of the second instruction indicator and the first point indicator of which the display form is changed when the first turn point is included in the AR view or a FOV of the camera; and displaying the second instruction indicator without displaying the first point indicator of which the display form is changed when the first turn point is not included in the AR view or the FOV of the camera.

The second instruction indicator may include an arrow that indicates a direction from a current location of the user terminal to the second turn point or the destination point and a plurality of dots or a line that connects from the arrow to the second turn point or the destination point.

The displaying of the second instruction indicator may include displaying the second instruction indicator when the second turn point or the destination point is not included in the AR view or the FOV of the camera, and the route guidance method may further include displaying a second point indicator that guides to the second turn point or the destination point without displaying the second instruction indicator when the second turn point or the destination point is included in the AR view or the FOV of the camera.

A location at which the first point indicator is displayed in the image may be determined based on a location of a vanishing point of the image.

The providing of the route guidance may include searching again for the route to the destination when a location of the user terminal deviates from the route by a desired distance or more.

According to another aspect of at least one example embodiment, there is provided a route guidance method performed by a user terminal, the route guidance method including acquiring a route from a source to a destination set by a user of the user terminal; and providing route guidance from the source to the destination through an AR view that includes an image captured by a camera of the user terminal, based on the route. The route includes at least one turn point, and the providing of the route guidance includes, in response to the user terminal moving toward the destination based on the route, displaying a first instruction indicator that instructs a movement to a first turn point approached by the user terminal among the at least one turn point through augmentation on the image; and displaying a second instruction indicator that instructs a movement to a second turn point to which the user terminal is to move after the first turn point in order to move toward the destination among the at least one turn point or a destination point indicating the destination, without displaying the first instruction indicator, when a distance from the user terminal to the first turn point is a desired value or less.

According to another aspect of at least one example embodiment, there is provided a computer system that implements a user terminal, the computer system including at least one processor configured to execute computer-readable instructions included in a memory. The at least one processor is configured to acquire a route from a source to a destination set by a user of the user terminal, the route including at least one turn point, and to provide route guidance from the source to the destination through an augmented reality (AR) view that includes an image captured by a camera of the user terminal, based on the route, and to, in response to the user terminal moving toward the destination based on the route, augment, on the image, and thereby selectively display a first point indicator that guides to a first turn point approached by the user terminal among the at least one turn point or a first instruction indicator that instructs a movement to the first turn point.

According to some example embodiments, by displaying a point indicator and an instruction indicator suitable for a situation as guidance information about turn point(s) included in an acquired or generated route when providing route guidance through an AR view, it is possible to provide suitable guidance information about a corresponding turn point when a camera is oriented toward a turn point approached by a user terminal (e.g., when the turn point is included in the AR view) and otherwise.

According to some example embodiments, even when a route displayed on an AR view is obstructed by topography and features of the real world, it is possible to provide suitable guidance information about turn point(s) included in the route.

According to some example embodiments, by displaying a first point indicator as guidance information about a first turn point included in a route and by displaying guidance information about a point to which a user (a user terminal) needs to move after the first turn point through a first point indicator, it is possible to provide a further effective route guidance.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram illustrating a route guidance method using an augmented reality (AR) view according to at least one example embodiment;

FIG. 2 is a block diagram illustrating an example of a computer system and a server for providing route guidance using an AR view according to at least one example embodiment;

FIG. 3 is a flowchart illustrating an example of a route guidance method using an AR view according to at least one example embodiment;

FIG. 4 is a flowchart illustrating an example of a method of displaying a first point indicator or a first instruction indicator as guidance information about a first turn point according to at least one example embodiment;

FIG. 5 is a flowchart illustrating an example of a method of displaying a first point indicator as guidance information about a first turn point according to at least one example embodiment;

FIG. 6 is a flowchart illustrating an example of a method of displaying a second point indicator or a second instruction indicator as guidance information about a point following a first turn point according to at least one example embodiment;

FIG. 7 is a flowchart illustrating an example of a method of searching again for a route in providing route guidance according to at least one example embodiment;

FIG. 8 illustrates an example of a route that includes turn points according to at least one example embodiment;

FIGS. 9A and 9B illustrate an example of augmented reality views displaying a point indicator or an instruction indicator as guidance information about a turn point according to at least one example embodiment;

FIGS. 10A and 10B illustrate diagrams displaying a point indicator as guidance information about a turn point according to at least one example embodiment;

FIGS. 11A and 11B illustrate diagrams displaying an instruction indicator as guidance information about a turn point according to at least one example embodiment;

FIGS. 12A and 12B illustrate diagrams displaying a first instruction indicator as guidance information about a first turn point and a second point indicator as guidance information about a second turn point according to at least one example embodiment;

FIG. 13 illustrates a diagram displaying an instruction indicator as guidance information about a turn point in the case of making a camera face downward, e.g., toward the ground, according to at least one example embodiment;

FIG. 14 illustrate a diagram displaying a first point indicator of which a display form is changed as guidance information about a first turn point and a second instruction indicator as guidance information about a point following the first turn point according to at least one example embodiment;

FIGS. 15A and 15B, and FIGS. 16A and 16B illustrate diagrams displaying a first instruction indicator as guidance information about a first turn point as the first turn point is approached and suspending displaying of the first instruction indicator and displaying a second instruction indicator as guidance information about a point following the first turn point according to at least one example embodiment;

FIG. 17 illustrates diagrams of an instruction indicator for a turn point according to at least one example embodiment; and

FIGS. 18A, 18B and 18C illustrate diagrams displaying forced conversion in route guidance through a user terminal according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION OF THE INVENTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flowcharts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, some example embodiments will be described with reference to the accompanying drawings.

The example embodiments relate to a method of providing route guidance from a source to a destination using an augmented reality (AR) view as a location-based AR service.

The route guidance in the example embodiments may be performed for an indoor space and/or an outdoor space. That is, at least one of the source and the destination may be an indoor location or an outdoor location and the route guidance may be performed not only indoors or outdoors but also in a complex area in which indoors and outdoors are combined. Hereinafter, an example embodiment is described based on route guidance outdoors with reference to the accompanying drawings.

The “destination” may be set as a location or a place at which a user desires to arrive through the use of a user terminal 100. The “source” may be the current location of the user. Alternatively, the “source” may be set by the user terminal 100.

In the following description, the location of the user terminal 100 may be explained as the location of the user having the user terminal 100 for clarity of description. Also, for clarity of description, the “user” and the “user terminal 100” of the user may be interchangeably used.

In the following description, “displaying through augmentation” on an image for content and/or information (e.g., an indicator) may be interpreted as encompassing overlappingly displaying the corresponding content and/or information on the image/screen depending on example embodiments.

The following example embodiments describe a method of providing suitable guidance information based on a situation of a turn point approached by the user terminal 100 in association with at least one turn point included in a route.

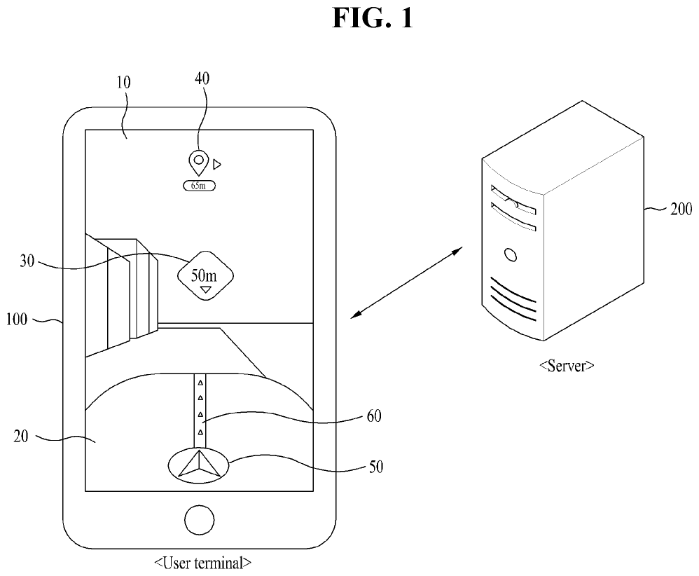

FIG. 1 illustrates an example of a route guidance method using an augmented reality (AR) view according to at least one example embodiment.

Referring to FIG. 1, the user terminal 100, for example, a smartphone may capture the surroundings using a camera and may be guided on a route 60 through an AR view 10 including an image captured by the camera. The AR view 10 and a map view 20 including a map matching the image of the AR view 10 may be displayed together on a screen of the user terminal 100. The map view 20 may include the route 60 and the current location 50 of the user terminal 100. The map view 20 may include a two-dimensional (2D) map or a three-dimensional (3D) map. In FIG. 1, displaying of a detailed map on the map view 20 is omitted.

A destination indicator 40 related to a destination and a point indicator 30 that guides to a turn point to which the user terminal 100 needs to move from the current location 50 in order to move toward the destination may be augmented and displayed on the image of the AR view 10. Referring to FIG. 1, the destination indicator 40 may display the remaining distance to the destination and the direction from the current location 50 to the destination. The point indicator 30 may display the distance from the current location 50 to a turn point related to the point indicator 30. The distance may gradually decrease as the user terminal 100 approaches the turn point.

The user may easily identify a turn point to which the user needs to move in order to arrive at the destination by referring to the point indicator 30. The turn point may refer to a point at which a turn (e.g., a left turn, a right turn, a U-turn, etc.) is required on the route 60. For example, each turn point included in the route 60 may be a point at which a turn of a desired angle or more is required on the route 60.

To provide route guidance using the AR view 10, the user terminal 100 may communicate with a server 200. In response to a request from the user of the user terminal 100, the server 200 may generate the route 60 to the destination and may transmit guidance information for being guided on the generated route 60 to the user terminal 100. That is, the user terminal 100 may acquire the route 60 generated by the server 200. The route 60 to the destination may be generated based on a plurality of nodes and links preset on a map that includes the destination.

The server 200 may store and maintain data for generating the route guidance information about the route 60. For example, the server 200 may be a map server that provides a digital map such as a 3D map and/or a 2D map.

As described above, when providing route guidance, the user terminal 100 may further display the map view 20 that includes a map matching the image of the AR view 10, together with the AR view 10. Therefore, the user may find the destination by referring to not only the image displayed through the AR view 10 but also the map corresponding thereto.

In an example embodiment, the user terminal 100 may display the point indicator 30 and an instruction indicator (not shown in FIG. 1) suitable for a situation as guidance information about a turn point included in the route 60 acquired or generated by the server 200. Therefore, when the camera on the user terminal 100 is oriented toward the turn point approached by the user terminal 100 (e.g., when the turn point is included in the AR view 10 as in FIG. 1) and otherwise, the user terminal 100 may provide suitable guidance information about the turn point.

That is, in the example embodiments, although the user does not necessarily orient the user terminal 100 toward a specific turn point, suitable guidance information about the corresponding turn point may be displayed on the screen of the user terminal 100.

The location at which the point indicator 30 is augmented and displayed in the image may be preset as a location at which the user may easily identify the point indicator 30. For example, a location at which the point indicator 30 is augmented and displayed in the image may be determined based on the location of a vanishing point of the image (i.e., a vanishing point of a camera view within the screen). The location at which the point indicator 30 is augmented and displayed in the image may be determined as a location collinear with the location of the vanishing point.

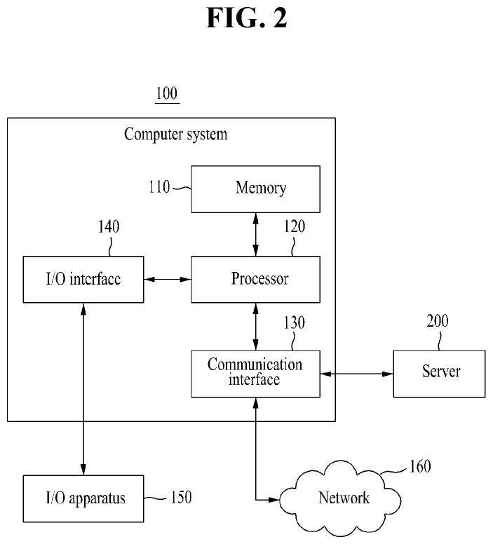

A method of displaying the point indicator 30 and the instruction indicator as guidance information about a turn point is further described with reference to FIGS. 2 to 16B.

FIG. 2 is a diagram illustrating an example of a computer system and a server providing a route guidance method using an AR view according to at least one example embodiment.

The user terminal 100 of FIG. 1 according to the example embodiments may be implemented through a computer system 100. For example, a computer program for implementing a method according to the example embodiments may be installed and run on the computer system 100 and the computer system 100 may perform a route guidance method according to the example embodiments under the control of the running computer program.

The route guidance method according to the example embodiments may be implemented through a PC-based program or a dedicated application of a mobile terminal. For example, the route guidance method may be implemented in a form of a program that independently operates or may be implemented in an in-app form of a specific application to be operable on the specific application. The specific application may be installed on the computer system and may provide augmented reality (AR)-based route guidance and perform the route guidance method.

The computer system 100 may be a smartphone and a device similar thereto that may install and execute an application or a program as illustrated in FIG. 1. Also, the computer system 100 may be, for example, a personal computer (PC), a laptop computer, a tablet, an Internet of things (IoT) device, and a wearable computer.

Referring to FIG. 2, the computer system 100 may include a memory 110, a processor 120, a communication interface 130, and an input/output (I/O) interface 140 as components for performing the route guidance method.

The memory 110 may include a permanent mass storage device, such as a random access memory (RAM), a read only memory (ROM), and a disk drive, as a non-transitory computer-readable record medium. The permanent mass storage device, such as ROM and a disk drive, may be included in the computer system 100 as a permanent storage device separate from the memory 110. Also, an OS and at least one program code may be stored in the memory 110. Such software components may be loaded to the memory 110 from another non-transitory computer-readable record medium separate from the memory 110. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 110 through the communication interface 130, instead of the non-transitory computer-readable record medium. For example, the software components may be loaded to the memory 110 of the computer system 100 based on a computer program installed by files received over the network 160.

The processor 120 may be configured to process instructions of a computer program by performing basic arithmetic operations, logic operations, and I/O operations. The computer-readable instructions may be provided from the memory 110 or the communication interface 130 to the processor 120. For example, the processor 120 may be configured to execute received instructions in response to the program code stored in the storage device, such as the memory 110.

That is, the processor 120 may manage components of the computer system 100, and may execute a program or an application used by the computer system 100. For example, the processor 120 may be configured to execute an application for performing a route guidance method according to an example embodiment and to process data received from the server 200 to provide the route guidance. Also, the processor 120 may process an operation required for execution of the program or the application and processing of data. The processor 120 may be at least one processor of the computer system 100 or at least one core within the processor.

The communication interface 130 may provide a function for communication between the communication system 100 and another computer system (not shown) through the network 160. For example, the processor 120 of the computer system 100 may forward a request or an instruction created based on a program code stored in the storage device such as the memory 110, data, and a file, to other computer systems over the network 160 under the control of the communication interface 130. Inversely, a signal, an instruction, data, a file, etc., from another computer system may be received at the computer system 100 through the communication interface 130 of the computer system 100. For example, a signal, an instruction, data, etc., received through the communication interface 130 may be forwarded to the processor 120 or the memory 110, and a file, etc., may be stored in a storage medium, for example, the permanent storage device, further includable in the computer system 100. For example, the communication interface 130 may be a hardware module such as a network interface card, a network interface chip, and a networking interface port of the computer system 100, or a software module such as a network device driver and a networking program.

The I/O interface 140 may be a device used for interfacing with an I/O apparatus 150. For example, an input device of the I/O apparatus 150 may include a device, such as a microphone, a keyboard, a mouse, etc., and an output device of the I/O apparatus 150 may include a device, such as a display, a speaker, etc. As another example, the I/O interface 140 may be a device for interfacing with an apparatus in which an input function and an output function are integrated into a single function, such as a touchscreen. The I/O apparatus 150 may be configured as a single apparatus with the computer system 100.

According to other example embodiments, the computer system 100 may include greater or less number of components than the number of components shown in FIG. 2. For example, the computer system 100 may include at least a portion of I/O devices connected to the I/O interface 140, or may further include other components, for example, a transceiver, a global positioning system (GPS) module, a camera, various sensors, and a database. For example, if the computer system 100 is implemented in a form of a mobile device such as a smartphone, the computer system 100 may be implemented to further include various components, for example, a camera, an acceleration sensor or a gyro sensor, various physical buttons, a button using a touch panel, an I/O port, and a vibrator for vibration, which are generally included in the mobile device. The computer system 100 corresponding to the user terminal 100 may include a camera configured to capture surroundings to execute the AR view 10. The computer system 100 may display an image captured through the camera as the AR view 10, and may display a point indicator and/or an instruction indicator for turn point(s) included in the route 60 as guidance information through augmentation on the AR view 10.

The server 200 may be an electronic device that provides information/data for route guidance to the computer system 100 through communication with the computer system 100. The server 200 may include a database or may communicate with the database as a device that stores and maintains data for generating a route (from a source to a destination) and guidance information about the route. For example, the server 200 may be a map server that provides a digital map such as a 3D map and/or a 2D map. The server 200 may include at least one computer system. The computer system included in the server 200 may include components similar to those of the computer system 100 and further description related thereto is omitted.

In an example embodiment, when providing route guidance through the AR view 10, the user terminal 100, that is the computer system 100, may augment and display a point indicator and/or an instruction indicator on an image as guidance information about a turn point based on data and/or information provided from the server 200 through communication with the server 200.

In the following description, for clarity of explanation, example embodiments are described based on the computer system 100 corresponding to the user terminal 100 and description related to communication with the server 200 and an operation on a side of the server 200 may be simplified or omitted.

Also, in the following description, for clarity of explanation, it may be described that operations performed by a component (e.g., a processor, etc.,) of the computer system 100 (or the server 200) are described as being performed by the computer system 100 (or the server 200).

Description related to technical features made above with reference to FIG. 1 may apply to FIG. 2 and thus, further description is omitted.

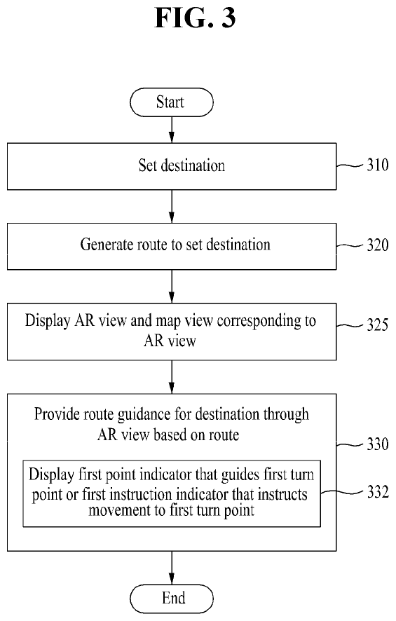

FIG. 3 is a flowchart illustrating an example of a route guidance method using an AR view according to at least one example embodiment.

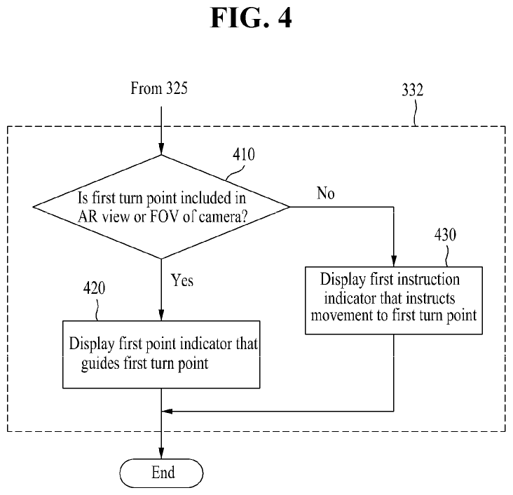

A route guidance method performed by the computer system 100 is described with reference to FIG. 3. The computer system 100 may correspond to the user terminal 100 of FIG. 1 and the following description is made using the term “user terminal 100” instead of the computer system 100. Also, at least a portion of the following operations 310 to 330 and operations described with reference to FIGS. 4 to 7 may be configured to be performed by not the user terminal 100 but the server 200. In the following, description related to operations is made based on the user terminal 100 and repeated description related to the server 200 is omitted.

Referring to FIG. 3, in operation 310, the user terminal 100 may set a destination. Setting of the destination may be performed by the user of the user terminal 100 through a user interface provided from an application that provides a route guidance service. Also, the user terminal 100 may set a source. Similar to the destination, the source may be set by the user through the user interface. Alternatively, the current location of the user, that is, the user terminal 100, may be set as the source.

In operation 320, the user terminal 100 may acquire the route 60 from the source to the set destination. The route 60 to the set destination may be generated by the server 200, and the user terminal 100 may acquire the route 60 generated by the server 200. Acquiring of the route 60 from the server 200 may relate to receiving information/data that represents the route 60 from the source to the destination. The acquired route 60 may include at least one of the shortest distance route, the minimum time route, and the optimal route from the source to the destination. When a plurality of routes is generated and provided to the user terminal 100, the user terminal 100 may provide guidance on the selected route 60 based on the selection received from the user.

At least a portion of arithmetic operations required for generating the route 60 may be performed by the user terminal 100.

The acquired route 60 may include at least one turn point. The turn point may represent a point at which a turn (e.g., a left turn, a right turn, a U-turn, etc.) is required on the route 60. For example, each turn point (or spot) included in the route 60 may be a point at which a turn of a predetermined (or alternatively, desired) angle or more is required on the route 60. The turn point may represent a point to which the user terminal 100 needs to move from a current location in order to move toward the destination. Meanwhile, the predetermined (or alternatively, desired) angle may be, for example, 45 degrees or 30 degrees.

In operation 330, the user terminal 100 may provide route guidance from the source to the destination through the AR view 10 that includes an image captured by the camera of the user terminal 100 based on the route 60 acquired in operation 320. That is, the user may move from the source to the destination by referring to guidance information that is augmented and displayed on the image of the AR view 10.

In an example embodiment, when the route 60 is acquired in operation 320, turn points included in the route 60 may be identified. As the user terminal 100 approaches the destination, guidance information (the following point indicator (or spot indicator) or instruction indicator) about a corresponding turn point may be displayed in the AR view 10 when approaching each of the turn points. For example, order may be assigned to each of the identified turn points (e.g., in order close to the destination on the route 60) and as the user terminal 100 sequentially approaches each of the turn points, guidance information about each turn point may be sequentially displayed in the AR view 10.

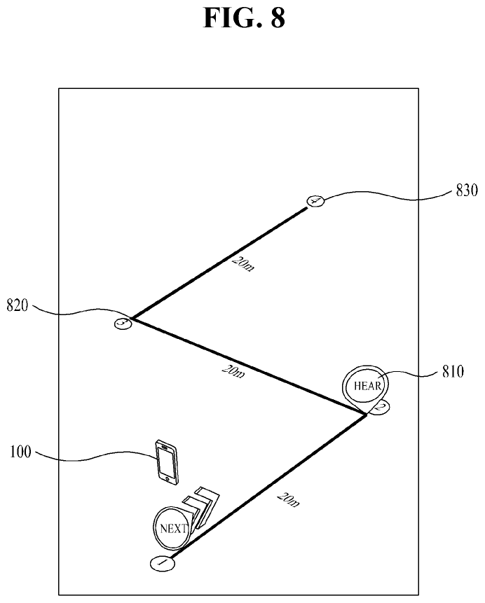

FIG. 8 illustrates an example of a route that includes turn points according to at least one example embodiment.

FIG. 8 illustrates a route that includes turn points 810, 820, and 830. The route of FIG. 8 may correspond to the route 60 of FIG. 1. The user terminal 100 may be guided to each of the turn points 810, 820, and 830 in order to move toward the destination. As the user terminal 100 approaches the turn point 810, guidance information (e.g., a point indicator) may be displayed in association with the turn point 810. When the user terminal 100 approaches the turn point 820, guidance information (e.g., a point indicator) may be displayed in association with the turn point 820. That is, as the user terminal 100 moves toward the destination, guidance information about each of the turn points 810, 820, and 830 may be sequentially provided when the user terminal 100 approaches each corresponding turn point.

In operation 332, as the user terminal 100 moves toward the destination based on the route 60, the user terminal 100 may display a first point indicator that guides to a first turn point or a first instruction indicator that instructs a movement to the first turn point as guidance information about the first turn point approached by the user terminal 100 among at least one turn point included in the route 60 through augmentation on the image. That is, the user terminal 100 may selectively display the first point indicator that guides to the first turn point or the first instruction indicator that instructs the movement to the first turn point according to a situation.

The user may recognize the first turn point to which the user needs to move from a current location through the first point indicator or the first instruction indicator displayed through augmentation on the image, and may move from the source to the destination accordingly. The first instruction indicator may connect the first turn point and the current location of the user terminal 100. In an example embodiment, the user terminal 100 may display the first point indicator that guides to the first turn point approached by the user terminal 100 through augmentation on the image. The first point indicator may correspond to the point indicator 30 of FIG. 1. The user terminal 100 may display the distance from the user terminal 100 to the first turn point on the first point indicator. The user may identify the location of the first turn point and the remaining distance to the first turn point through the first point indicator.

When the distance between the first turn point and the user terminal 100 is a predetermined (or alternatively, desired) value (e.g., 100 m) or less, the user terminal 100 may display the first point indicator at a position corresponding to the first turn point of the AR view 10. That is, when the distance between a specific turn point and the user terminal 100 reaches a predetermined (or alternatively, desired) value or less, the user terminal 100 may display a point indicator at the location corresponding to the corresponding turn point of the AR view 10. Therefore, a point indicator to a turn point close to the user terminal 100 may be dynamically displayed in the AR view 10 according to the movement of the user terminal 100.

A method of displaying the first point indicator or the first instruction indicator as guidance information about the first turn point according to a situation is further described below with reference to FIG. 4.

Referring again to FIG. 3, in operation 325, to provide route guidance to the destination, the user terminal 100 may display the map view 20 that includes a map matching the image of the AR view 10 with the AR view 10. The map view 20 may include the route 60 and the current location 50 of the user terminal 100. The map view 20 may be a 2D map or a 3D map.

As described above with reference to FIG. 1, the map view 20 may be displayed at a lower end of the screen of the user terminal 100. The map view 20 may be a 3D map and may be tilted to three-dimensionally identify objects on the map. For clarity of explanation, a detailed map of the map view 20 is omitted in the drawings.

The map displayed on the map view 20 may be zoomed out more than the image of the AR view 10. That is, the map view 20 may provide information about a wider area than the image of the AR view 10. The user may more easily find the destination by referring to the image of the AR view 10 and the map view 20.

Technical features made above with reference to FIGS. 1 and 2 may apply to FIGS. 3 and 8 and thus, further description is omitted.

FIG. 4 is a flowchart illustrating an example of a method of displaying a first point indicator or a first instruction indicator as guidance information about a first turn point according to at least one example embodiment.

Referring to FIG. 4, in operation 410, the user terminal 100 may determine whether a first turn point is included in the AR view 10 or a field of view (FOV) of a camera. For example, the user terminal 100 may determine whether the first turn point is included in the range of an angle of view (or an angle of FOV) of the camera. When the user terminal 100 is provided such that the camera of the user terminal 100 may be oriented toward a location corresponding to the first turn point or when the user terminal 100 is provided such that the location corresponding to the first turn point may be displayed in the AR view 10, the first turn point may be determined to be included in the AR view 10 or the FOV of the camera. The FOV of the camera may include all of top, bottom, left, and right angles of the camera.

In operation 420, when the first turn point is included in, that is, determined to be included in the AR view 10 or the FOV of the camera, the user terminal 100 may display the first point indicator that guides to the first turn point through augmentation on the image of the AR view 10.

In operation 430, when the first turn point is not included in, that is, determined not to be included in the AR view 10 or the FOV of the camera, the user terminal 100 may display the first instruction indicator that instructs the movement to the first turn point through augmentation on the image of the AR view 10, without displaying the first point indicator that guides to the first turn point.

As described above, only when the first turn point (associated with the first instruction indicator) is not included in the AR view 10 or the FOV of the camera in displaying the first instruction indicator, the user terminal 100 may display the first instruction indicator. When the first turn point (associated with the first instruction indicator) is included in the AR view 10 or the FOV of the camera, the first point indicator may be displayed and displaying of the first instruction indicator may not be required accordingly.

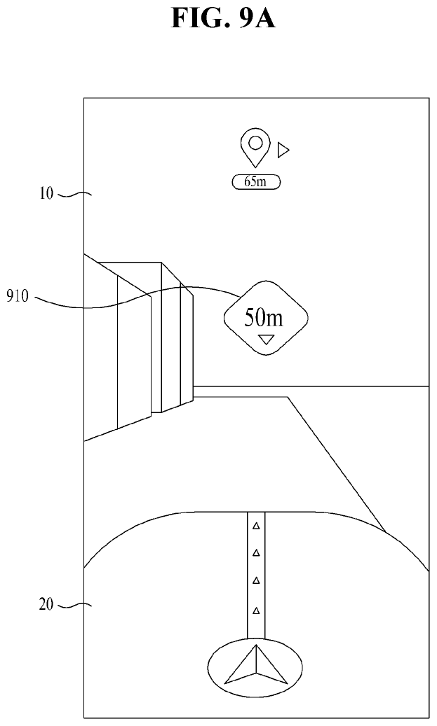

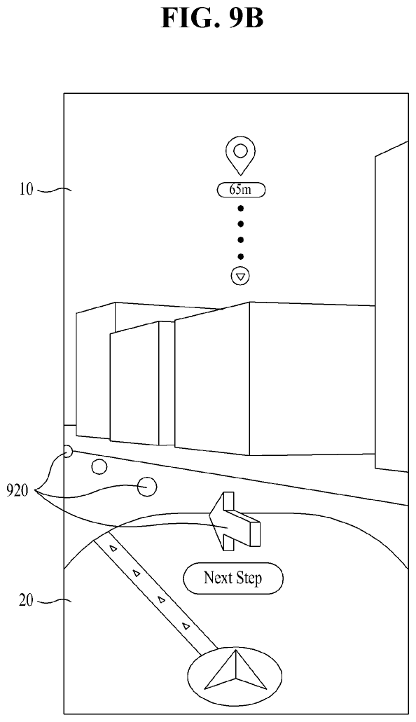

FIGS. 9A and 9B illustrate an example of displaying a point indicator or an instruction indicator as guidance information about a turn point.

FIGS. 9A and 9B illustrate an example of the user terminal 100 on which the AR view 10 and the map view 20 are displayed.

Referring to FIG. 9A, when a first turn point is included in the AR view 10 or the FOV of a camera, the user terminal 100 may display a first point indicator 910 that guides to the first turn point through augmentation on an image of the AR view 10. The first point indicator 910 may indicate the remaining distance from the current location of the user terminal 100 to the first turn point as 50 m. The distance to the first turn point may gradually decrease as the user terminal 100 approaches the first turn point. Meanwhile, a destination indicator 40 indicating the distance and the direction to a destination may be further displayed on the AR view 10.

The user may easily identify the location of the first turn point and the distance to the first turn point through the first point indicator 910.

Referring to FIG. 9B, when the first turn point is not included in the AR view 10 or the FOV of the camera, the user terminal 100 may display a first instruction indicator 920 that instructs a movement to the first turn point through augmentation on the image of the AR view 10. In FIG. 9B, the AR view 10 may not display a location corresponding to the first turn point, which differs from FIG. 9A. Here, the first turn point may not be included in the FOV of the camera of the user terminal 100.

The first instruction indicator 920 instructs the movement to the first turn point and may include a first element that indicates a direction from the current location of the user terminal 100 to the first turn point and a second element that connects from the first element to the first turn point. For example, the first element of the first instruction indicator 920 may include an arrow that indicates a direction from the current location of the user terminal 100 to the first turn point, and the second element of the first instruction indicator 920 may include a dot(s) or a line that connects from the first element to the first turn point. The illustrated arrow and dot may be replaced with any other symbol, such as a line, a bar, and a dash.

The user may easily identify a direction in which the location of the first turn point is present through the first instruction indicator 920 and may move to the first turn point along the direction indicated by the first instruction indicator 920.

The first instruction indicator 920 may be displayed to direct to the first turn point. In displaying the first instruction indicator 920, the user terminal 100 may display the first instruction indicator 920 to direct to the first turn point according to the rotation of the camera (i.e., according to a change in displaying of the AR view 10 according to the rotation of the camera). The rotation of the camera may refer to a rotation in an x-axial direction, a y-axial direction, and a z-axial direction and may be one of yaw, pitch, and roll.

As described above, although the user terminal 100 is not provided to direct the user to the first turn point, the first instruction indicator 920 may be augmented and displayed on the AR view 10. Therefore, when the user is provided with route guidance through the user terminal 100, the user may be properly provided with guidance on the location of the first turn point (to which the user needs to move) although the user terminal 100 faces downward.

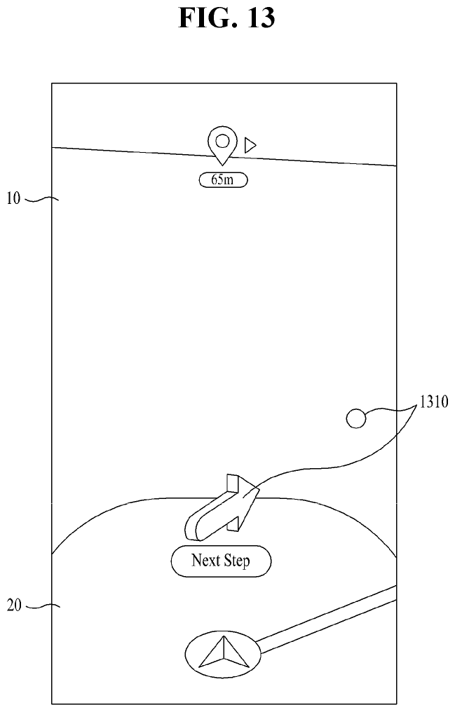

FIG. 13 illustrates an example of a method of displaying an instruction indicator as guidance information about a turn point in the case of making a camera face downward (e.g., toward the ground) according to at least one example embodiment.

Referring to FIG. 13, the AR view 10 displays (almost) only a floor as the camera faces downward. Even in this case, an instruction indicator 1310 may properly guide to a turn point to which the user terminal 100 is to move. Even when the camera faces downward, the user may easily move to the turn point to which the user needs to move through the instruction indicator 1310.

Also, when displaying the first instruction indicator 920, the user terminal 100 may display the first instruction indicator 920 in a boundary between the map view 20 and the AR view 10. For example, the user terminal 100 may augment and display the first element of the first instruction indicator 920 in the boundary between the map view 20 and the AR view 10, and may augment and display the second element in the image. Therefore, the user may easily compare a direction corresponding to the current location of the user (i.e., a direction toward the camera or the user terminal 100, for example, a direction indicated by the current location 50 in the map view 20 of FIG. 1) to a direction for moving to the first turn point indicated through the first instruction indicator 920 and accordingly, may easily verify a direction in which the user needs to move.

Referring to FIG. 9B, the first instruction indicator 920 may further include text information (e.g., “Next Step” in FIG. 9B) related to the first turn point to which the user needs to subsequently move.

As described above, according to an example embodiment, the first point indicator 910 or the first instruction indicator 920 may be properly displayed depending on whether the first turn point is included in the AR view 10 or the FOV of the camera and guidance suitable for a situation may be provided for the first turn point.

Description related to technical features made above with reference to FIGS. 1 to 3 and 8 may apply to FIGS. 4, 9A, 9B, and 13 as is and thus, further description is omitted.

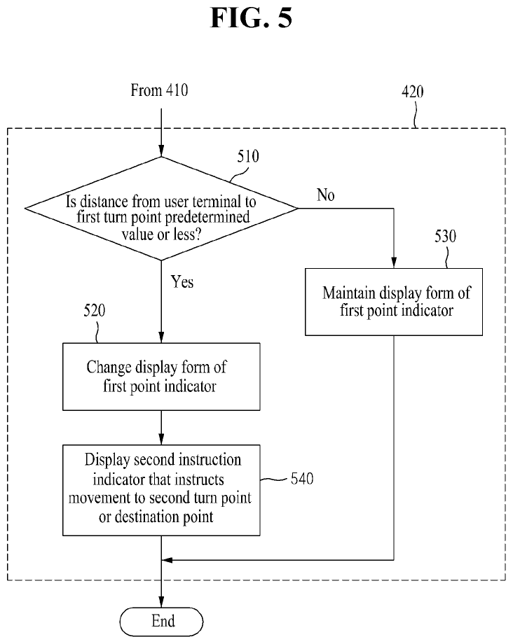

FIG. 5 is a flowchart illustrating an example of a method of displaying a first point indicator as guidance information about a first turn point according to at least one example embodiment.

A method of changing a display form of the first point indicator as guidance information that guides to the first turn point is described with reference to FIG. 5.

In operation 510, the user terminal 100 may determine whether the distance from the user terminal 100 to the first turn point is a predetermined (or alternatively, desired) value or less. The predetermined (or alternatively, desired) value may be a value preset by the user terminal 100 or the server 200, such as, for example, 20 m.

In operation 520, when the distance from the user terminal 100 to the first turn point is the predetermined (or alternatively, desired) value or less, the user terminal 100 may change the display form of the first point indicator. Changing the display form may relate to changing at least one of the size, the color, and the shape of the first point indicator.

In operation 530, when the distance from the user terminal 100 to the first turn point is greater than the predetermined (or alternatively, desired) value, the user terminal 100 may maintain the display form of the first point indicator.

For example, as the user terminal 100 gradually approaches the first turn point, the user terminal 100 may maintain the display form of the first point indicator in the same display form before the distance between the first turn point and the user terminal 100 reaches 20 m (e.g., a display form in which only the distance between the first turn point and the user terminal 100 changes as in the point indicator 30 of FIG. 1 or the first point indicator 910 of FIG. 9A), and may change the display form of the first point indicator after the distance between the first turn point and the user terminal 100 reaches 20 m or less.

The first point indicator of which the display form is changed may include information that guides to a second turn point to which the user terminal 100 is to move after the first turn point in order to move toward the destination among at least one turn point included in the route 60 or a destination point indicating the destination (i.e., when a point to which the user terminal 100 is to move after the first turn point is the destination). Here, the first point indicator of which the display form is changed may include a symbol (e.g., an arrow, a symbol “>>,” etc.) indicating the direction toward the second turn point or the destination point.

That is, the user may be guided to a point to which the user needs to move after the first turn point through the first point indicator of which the display form is changed (when the user is located close enough to the first turn point). Therefore, the user may move to the next point without directly going through the first turn point and a more efficient route guidance for the destination may be provided to the user.

In operation 540, the user terminal 100 may display a second instruction indicator that instructs a movement to a second turn point corresponding to a point following the first turn point or the destination point through augmentation on the image of the AR view 10. The second instruction indicator may be displayed from a moment at which the distance from the user terminal 100 to the first turn point becomes a predetermined (or alternatively, desired) value (e.g., 20 m) or less. That is, when the user terminal 100 approaches the first turn point by a predetermined (or alternatively, desired) distance or more, an orientation point of an instruction indicator may be changed to the next turn point (or the destination point).

Here, when the first turn point is included in the AR view 10 or the FOV of the camera in displaying the second instruction indicator, the user terminal 100 may display the second instruction indicator with the first point indicator of which the display form has changed. When the first turn point is not included in the AR view 10 or the FOV of the camera, the user terminal 100 may display the second instruction indicator without displaying the first point indicator of which the display form has changed (i.e., by suspending displaying of the first point indicator).

The aforementioned description related to the first instruction indicator may apply to the second instruction indicator and thus, further description is omitted.

Similar to the first instruction indicator, the second instruction indicator may include a first element (e.g., an arrow) that indicates a direction from the current location of the user terminal 100 to the second turn point or the destination point and a second element (e.g., dot(s) or a line) that connects from the first element (the arrow) to the second turn point or the destination point.

According to example embodiments, when the user is located close enough to the first turn point, an instruction indicator that instructs a movement to the next point to which the user needs to move may be displayed on the user terminal 100 with guidance for the next point to which the user needs to move after the first turn point through the first point indicator of which the display form has changed. Also, when the AR view 10 does not include the first turn point according to the movement of the camera, only the instruction indicator that instructs the movement to the next point to which the user needs to move may be displayed on the user terminal 100. Therefore, a more effective guidance for the next movement point may be provided.

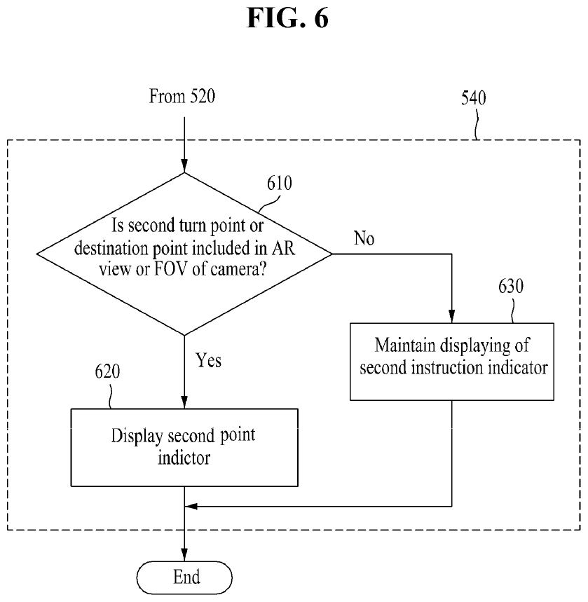

Hereinafter, a method of displaying the second instruction indicator is further described with reference to FIG. 6.

FIG. 6 is a flowchart illustrating an example of a method of displaying a second point indicator or a second instruction indicator as guidance information about a point following a first turn point according to at least one example embodiment.

In operation 610, the user terminal 100 may determine whether a second turn point is included in the AR view 10 or a FOV of a camera. For example, the user terminal 100 may determine whether the second turn point is included in an angle of view (or an angle of FOV) of the camera. When the user terminal 100 is provided such that the camera of the user terminal 100 may direct the user to a location corresponding to the second turn point, or when the user terminal 100 is provided such that the location corresponding to the second turn point is displayed in the AR view 10, the second turn point may be determined to be included in the AR view 10 or the FOV of the camera.

In operation 630, when the second turn point or the destination point is not included, that is, determined not to be included in the AR view 10 or the FOV of the camera, the user terminal 100 may display the second instruction indicator.

In operation 620, when the second turn point or the destination point is included (i.e., determined to be included) in the AR view 10 or the FOV of the camera, the user terminal 100 may display a second point indicator that guides to the second turn point or the destination point without displaying the second instruction indicator (i.e., by suspending displaying of the second instruction indicator). The aforementioned description related to the first point indicator may apply to the second point indicator and thus, further description is omitted.

As described above, only when the second turn point or the destination point (associated with the second instruction indicator) is not included in the AR view 10 or the FOV of the camera, the user terminal 100 may display the second instruction indicator. When the second turn point or the destination point (associated with the second instruction indicator) is included in the AR view 10 or the FOV of the camera, the second point indicator may be displayed and displaying of the second instruction indicator may not be required accordingly.

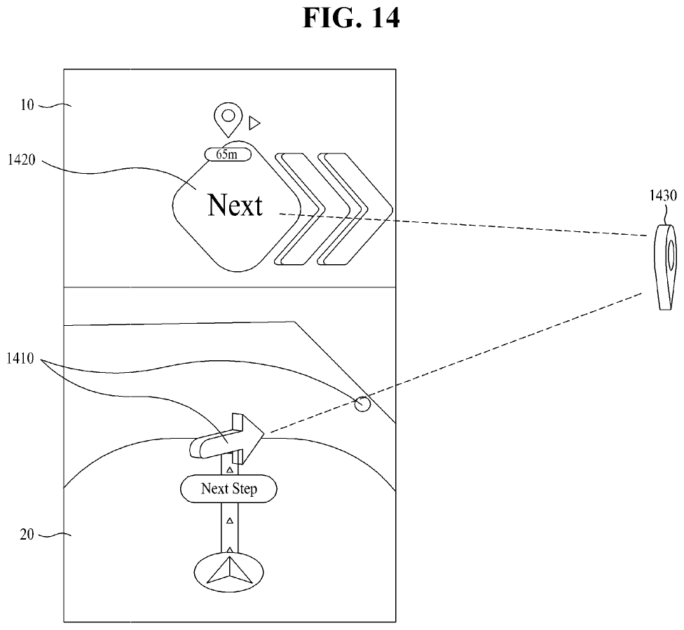

FIG. 14 illustrate an example of a method of displaying a first point indicator of which a display form has changed as guidance information about a first turn point and a second instruction indicator as guidance information about a point following the first turn point according to at least one example embodiment.

FIG. 14 illustrates a first point indicator 1420 of which a display form has changed from a first point indicator that guides to a first turn point and a second instruction indicator 1410 that instructs a movement to a destination point (or a second turn point) 1430 that is a point following the first turn point.

For example, referring to FIG. 14, as the user terminal 100 approaches the first turn point within a predetermined (or alternatively, desired) distance (e.g., 20 m), the first point indicator 1420 of which the display form has changed is displayed. The first point indicator 1420 may represent a direction to the destination point 1430 that is the point following the first turn point. The first point indicator 1420 may further include text information (e.g., “Next” in FIG. 14) related to the destination point 1430. The display form of the first point indicator 1420 may differ from the display form of the point indicator 30 of FIG. 1 and the display form of the first point indicator 910 of FIG. 9. The user terminal 100 may display the second instruction indicator 1410 that instructs a movement to the destination point 1430 with the first point indicator 1420. The second instruction indicator 1410 may be displayed to direct to the destination point 1430. Unless the first turn point is included in the AR view 10 or the FOV of the camera, the user terminal 100 may suspend displaying of the first point indicator 1420 and may display only the second instruction indicator 1410. Also, when the second turn point is included in the AR view 10 or the FOV of the camera, the user terminal 100 may suspend displaying of the second instruction indicator 1410 and may display the second point indicator.

According to an example embodiment, proper guidance for the first turn point approached by the user terminal 100 and the next point thereof, for example, the second turn point or the destination point 1430 may be provided according to a situation.

Description related to technical features made above with reference to FIGS. 1 to 4, 8, 9A, 9B, and 13 may apply to FIGS. 5, 6, and 14 and thus, further description is omitted.

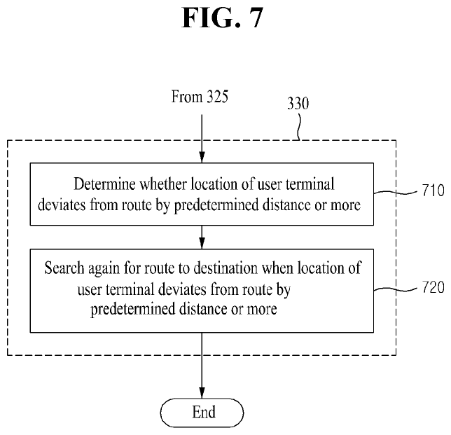

FIG. 7 is a flowchart illustrating an example of a method of searching again for a route in providing route guidance according to at least one example embodiment.

A method of providing route guidance from a source to a destination through an AR view in operation 330 is further described with reference to FIG. 7.

Referring to FIG. 7, in operation 710, the user terminal 100 may determine whether the location of the user terminal 100 deviates from the route 60 acquired in operation 320 by a predetermined (or alternatively, desired) distance or more.

In operation 720, when the location of the user terminal 100 deviates from the route 60 by the predetermined (or alternatively, desired) distance or more, the user terminal 100 may search again for the route to the destination. The predetermined (or alternatively, desired) distance may be set by the user of the user terminal 100 or the server 200. When the user is determined to have deviated from the route 60, the user terminal 100 may search again for the route to the destination and the route may be regenerated accordingly. That is, the server 200 may regenerate the route and the user terminal 100 may reacquire the route.

Description related to technical features made above with reference to FIGS. 1 to 6, 8, 9A, 9B, 13, and 14 may apply to FIG. 7 and thus, further description is omitted.

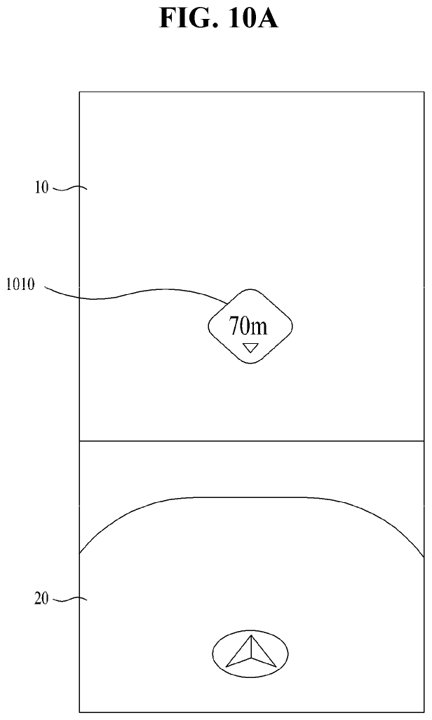

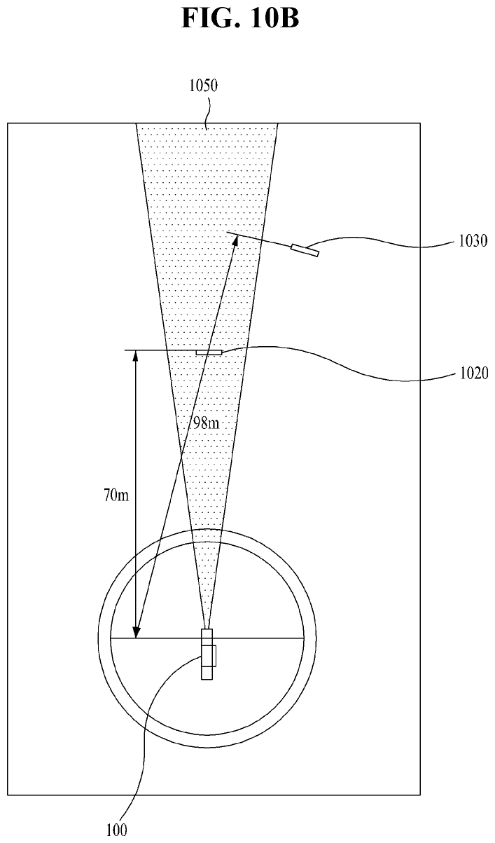

FIGS. 10A and 10B illustrate an example of a method of displaying a point indicator as guidance information about a turn point according to at least one example embodiment.

FIGS. 10A and 10B illustrate an example of displaying a first point indicator 1010 that guides to a first turn point 1020 in the AR view 10 when the first turn point 1020 is included and a second turn point 1030 is not included in a FOV 1050 of a camera of the user terminal 100.

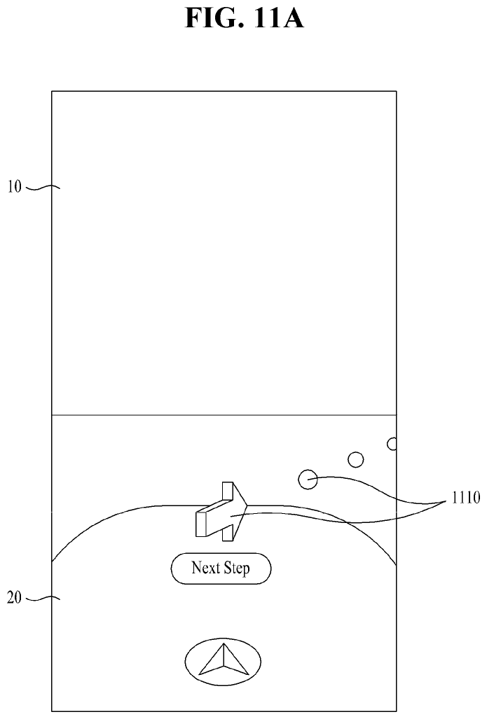

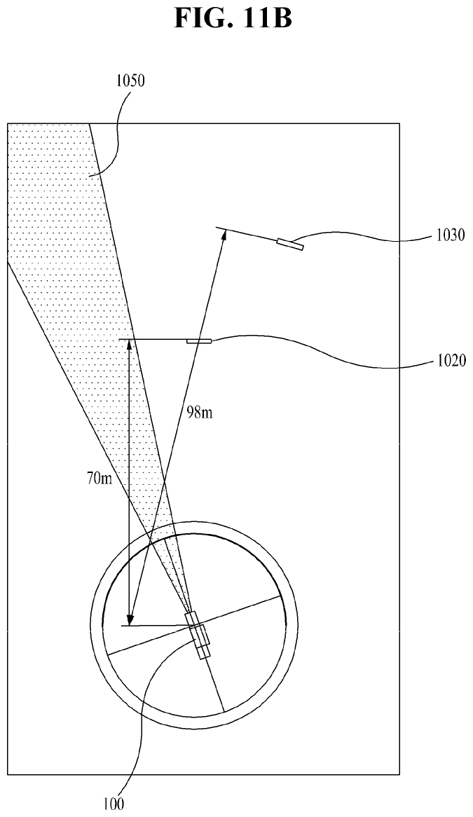

FIGS. 11A and 11B illustrate an example of a method of displaying an instruction indicator as guidance information about a turn point according to at least one example embodiment.

FIGS. 11A and 11B illustrate an example of displaying a first instruction indicator 1110 that instructs a movement to the first turn point 1020 in the AR view 10 when both the first turn point 1020 and the second turn point 1030 are not included in the FOV 1050 of the user terminal 100.

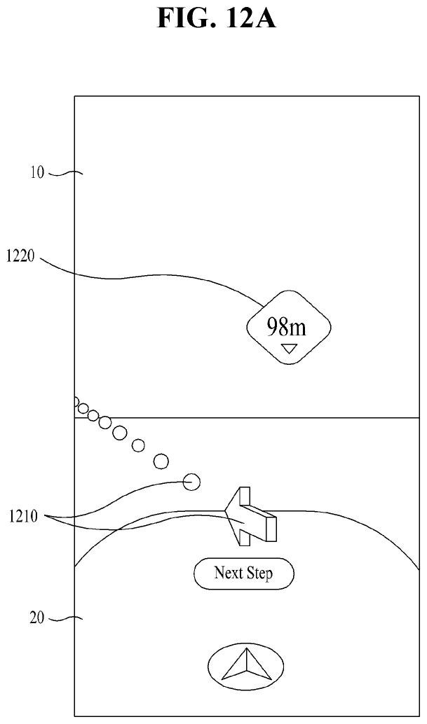

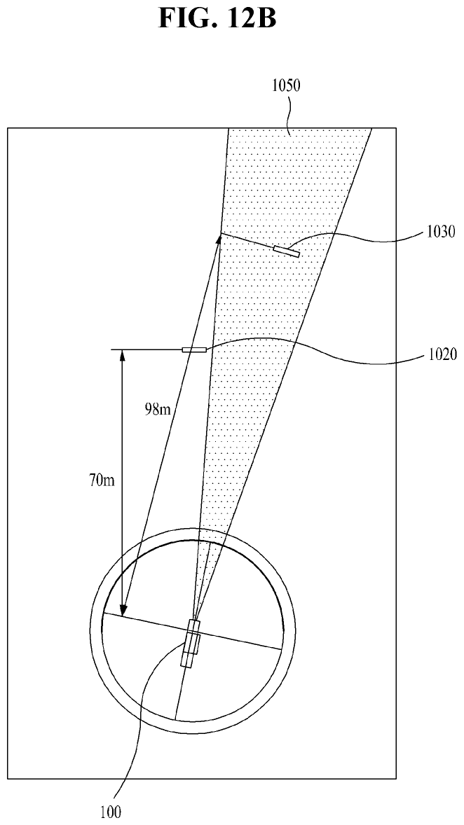

FIGS. 12A and 12B illustrate an example of a method of displaying a first instruction indicator as guidance information about a first turn point and a second point indicator as guidance information about a second turn point according to at least one example embodiment.

FIGS. 12A and 12B illustrate an example of displaying a first instruction indicator 1210 that instructs a movement to the first turn point 1020 and a second point indicator 1220 that guides to the second turn point 1030 in the AR view 10, when the second turn point 1030 is included and the first turn point 1020 is not included in the FOV 1050 of the camera of the user terminal 100.

Referring to FIGS. 12A and 12B, it may be assumed that the first turn point 1020 is 70 m away from the user terminal 100 and the second turn point 1030 is 98 m away from the user terminal 100.

As in the example of FIGS. 10A and 10B, when the first turn point 1020 is included in the FOV 1050 of the camera of the user terminal 100 (i.e., when the first turn point 1020 is included in the AR view 10, only the first point indicator 1010 may be displayed. Here, the first point indicator 1010 may indicate the distance from the user terminal 100 as 70 m.

As in the example of FIGS. 11A and 11B, when the first turn point 1020 is not included in the FOV 1050 (i.e., when the first turn point 1020 is not included in the AR view 10) due to a change in the FOV 1050 of the camera of the user terminal 100, displaying of the first point indicator 1010 may be suspended and the first instruction indicator 1110 may be displayed. The first instruction indicator 1110 may be displayed to direct to the first turn point 1020.

As in the example of FIGS. 12A and 12B, when the first turn point 1020 is not included and the second turn point 1030 is included in the FOV 1050 (i.e., when the second turn point 1030 is included in the AR view 10) due to a change in the FOV 1050 of the camera of the user terminal 100, the second point indicator 1220 that guides to the second turn point 1030 may be displayed with the first instruction indicator 1210. The first instruction indicator 1210 may be displayed to direct to the first turn point 1020. The second point indicator 1220 may indicate the distance from the user terminal 100 as 98 m.

Here, the user may immediately move toward the second turn point 1030. When the distance from the user terminal 100 to the second turn point 1030 is less than the distance from the user terminal 100 to the first turn point 1020, the user terminal 100 may suspend displaying of the first instruction indicator 1210, that is, may display only the second point indicator 1220. When the second turn point 1030 is not included in the FOV 1050 due to a change in the FOV 1050 of the camera, the second instruction indicator that instructs a movement to the second turn point 1030 may be displayed. In this manner, guidance for the second turn point 1030 may be properly provided.

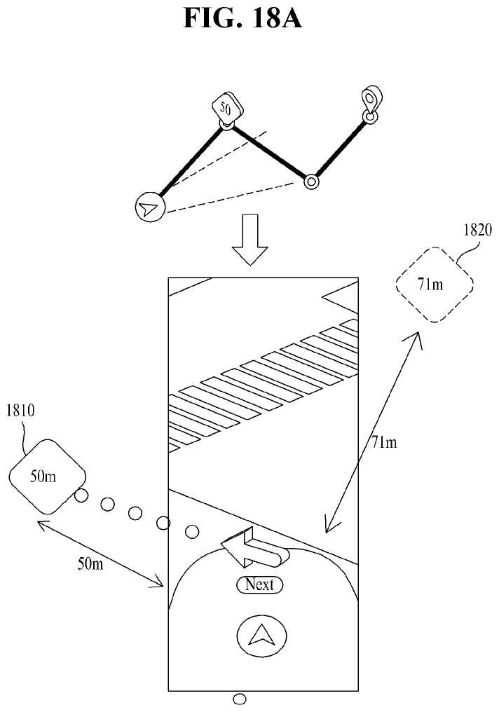

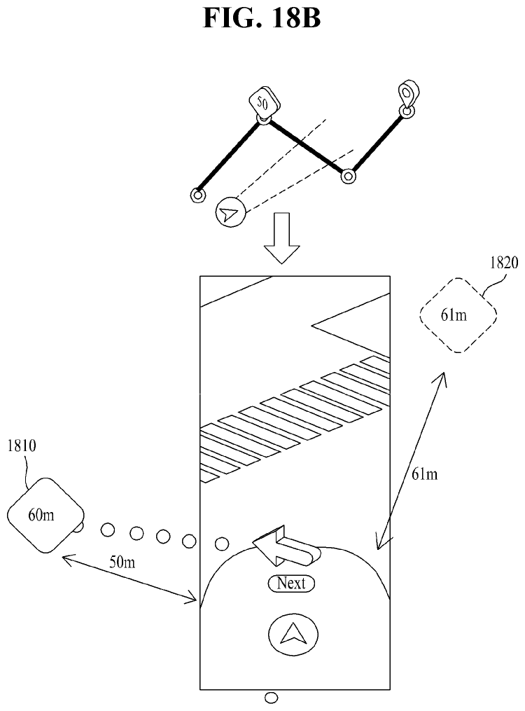

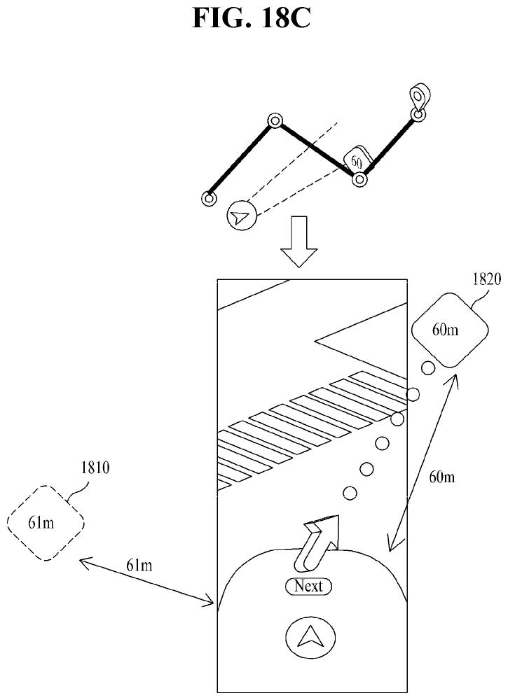

Referring to the example embodiments of FIGS. 10A to 12B, in a case in which the point to which the user terminal 100 needs to move after the first turn point 1020 is the second turn point 1030 or the destination point, the user terminal 100 may display the second point indicator 1220 that guides to the second turn point 1030 or the destination point along with the first instruction indicator 1110 (or the first instruction indicator 1210) when the second turn point 1030 or the destination point is included in the AR view 10 or the FOV 1050 of the camera in displaying the first instruction indicator 1110, 1210. Here, when the distance from the user terminal 100 to the first turn point 1020 is less than the distance from the user terminal 100 to the second turn point 1030 or the destination point, the user terminal 100 may display the second point indicator 1220 and the first instruction indicator 1110 (or the first instruction indicator 1210) together. When the distance from the user terminal 100 to the first turn point 1020 is greater than the distance from the user terminal 100 to the second turn point 1030 or the destination point, the first instruction indicator 1110, 1210 may not be displayed (i.e., displaying of the first instruction indicator 1110, 1210 may be suspended) and the user terminal 100 may display only the second point indicator 1220. Here, the user terminal 100 may determine that the user has passed through the first turn point 1020 and has moved toward the next point, that is, the second turn point 1030 or the destination point (a forced conversion). Further description related to the forced conversion is made with reference to FIG. 18.

As described above, a point indicator related to a specific turn point may be displayed when the distance between the user terminal 100 and the specific turn point is a predetermined (or alternatively, desired) value or less. Therefore, according to the movement of the user terminal 100, a point indicator (corresponding to a close turn point) may be dynamically displayed in the AR view 10 based on the current location of the user terminal 100. Therefore, the user may intuitively move toward a destination while verifying the displayed point indicator.

Description related to technical features made above with reference to FIGS. 1 to 9A and 9B, 13, and 14 may apply to FIGS. 10A to 12B and thus, further description is omitted.

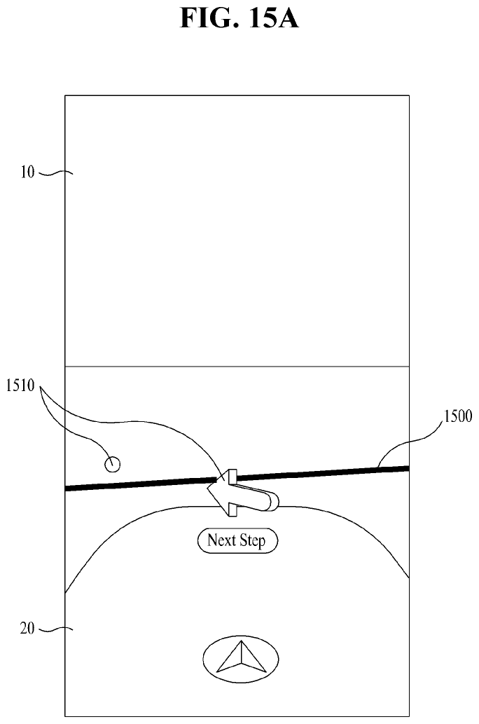

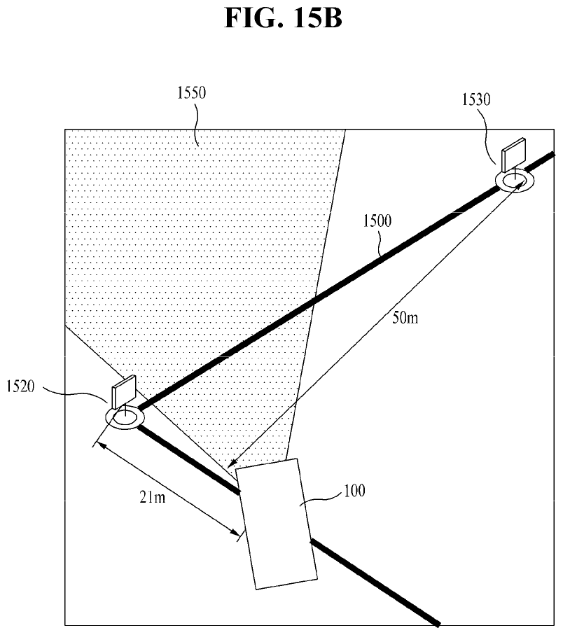

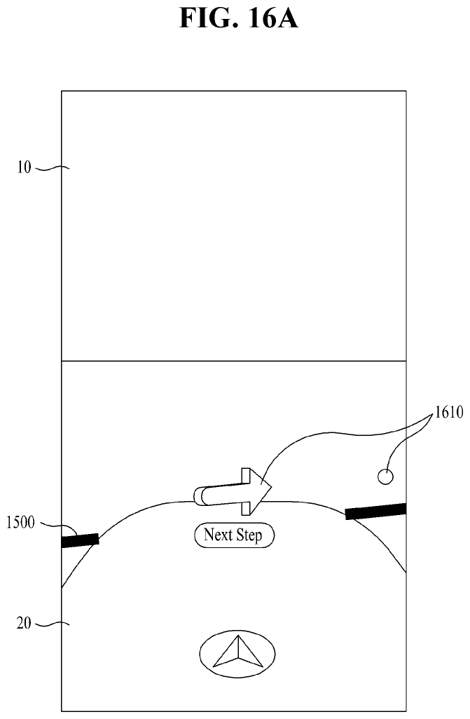

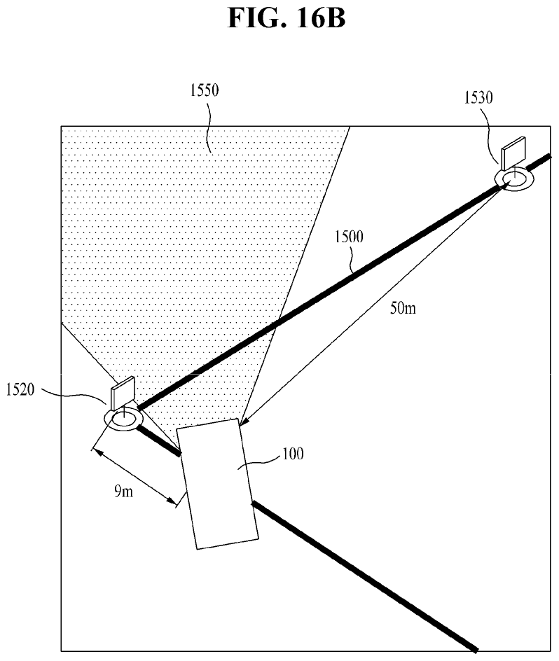

FIGS. 15A and 15B, and FIGS. 16A and 16B illustrate an example of a method of displaying a first instruction indicator as guidance information about a first turn point as the first turn point is approached and suspending displaying of the first instruction indicator and displaying a second instruction indicator as guidance information about a point following the first turn point according to at least one example embodiment.

An example of suspending displaying of a first instruction indicator 1510 that directs to a first turn point 1520 and displaying a second instruction indicator 1610 that directs to a second turn point 1530 corresponding to the next point in response to the user terminal 100 approaching within a predetermined (or alternatively desired) distance from the first turn point 1520 (without displaying the aforementioned point indicator) is described with reference to FIGS. 15A to 16B.

FIGS. 15A and 15B illustrate an example of displaying only the first instruction indicator 1510 when the user terminal 100 approaches the first turn point 1520 in a case in which neither the first turn point 1520 nor the second turn point 1530 are included in a FOV 1550 of a camera of the user terminal 100.

FIGS. 16A and 16B illustrate an example of suspending displaying of the first instruction indicator 1510 and displaying the second instruction indicator 1610 when the user terminal 100 approaches the first turn point 1520 within a predetermined (or alternatively desired) distance in a case in which neither the first turn point 1520 nor the second turn point 1530 are included in the FOV 1550 of the camera of the user terminal 100.

Referring to FIGS. 15A to 16B, the user terminal 100 may approach the first turn point 1520 in a route 1500 from 21 m to 9 m. The distance from the user terminal 100 to the second turn point 1530 is maintained at about 50 m.

The examples of FIGS. 15A to 16B may refer to a method of displaying instruction indicators, for example, the first instruction indicator 1510 and the second instruction indicator 1610, as guidance information about turn points, for example, the first turn point 1520 and the second turn point 1530, when making the camera face downward (e.g., toward the ground), as described above with reference to FIG. 13. When the user terminal 100 approaches the first turn point 1520, the user terminal 100 may display the first instruction indicator 1510 directing to the first turn point 1520 until the distance from the first turn point 1520 is within a predetermined (or alternatively desired) value (e.g., 20 m) and may display the second instruction indicator 1610 directing to the second turn point 1530 corresponding to the next point from a moment at which the distance from the first turn point 1520 is within the predetermined (or alternatively desired) value.

Therefore, according to an example embodiment, the user terminal 100 may naturally provide guidance for the next target point as the user approaches a specific target point.

Referring to the example embodiments of FIGS. 15A to 16B, as the user terminal 100 moves toward the destination based on the route 1500, the user terminal 100 may display the first instruction indicator 1510 that instructs a movement to the first turn point 1520 approached by the user terminal 100 among at least one turn point included in the route 1500, through augmentation on the image of the AR view 10. Here, when the distance from the user terminal 100 to the first turn point 1520 is a predetermined (or alternatively desired) value or less, the user terminal 100 may not display the first instruction indicator 1510 (i.e., suspend displaying of the first instruction indicator 1510) and may display the second instruction indicator 1610 that instructs a movement to the second turn point 1530 to which the user terminal 100 needs to move after the first turn point 1520 or to the destination point in order to move toward the destination among the at least one turn point included in the route 1500.

Therefore, according to an example embodiment, although the user walks with the camera facing the ground, guidance for turn points included in the route 1500 may be properly provided.

Description related to technical features made above with reference to FIGS. 1 to 14 may apply to FIGS. 15A to 16B and thus, further description is omitted.

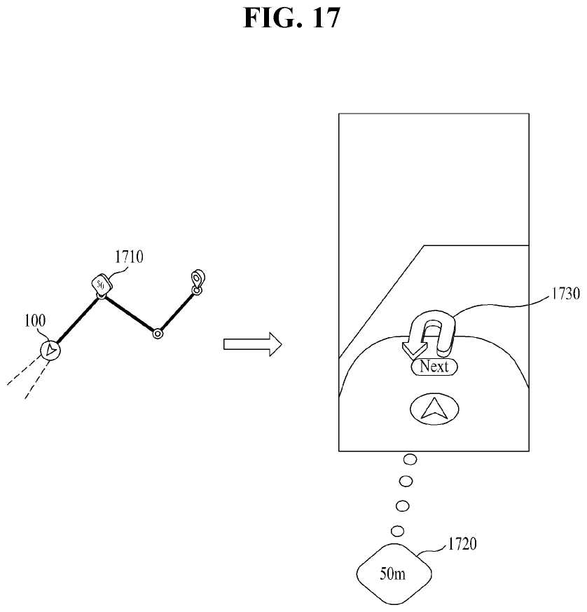

FIG. 17 illustrates an example of an instruction indicator for a turn point according to at least one example embodiment.

Referring to FIG. 17, an instruction indicator 1730 for instructing a movement to a turn point 1710 may be in a “U” shape indicating a U-turn. The shape of the instruction indicator 1730 may vary according to the direction directed by a camera of the user terminal 100 or an AR view. For example, when the angle of direction of the camera of the user terminal 100 or the AR view relative to the turn point 1710 or a point indicator 1720 corresponding to the turn point 1710 is in the range of 140 degrees to 220 degrees, the user terminal 100 may output the instruction indicator 1730 in the shape indicating a U-turn. Here, the display form of the instruction indicator 1730 displayed by the user terminal 100 may vary in real time (or almost in real time) according to the direction toward which the camera of the user terminal 100 or the AR view is oriented.

Therefore, the user may move toward a destination by referring to the instruction indicator 1730 that changes its display form and having an intuitive display form.

Description related to technical features made above with reference to FIGS. 1 to 16B may apply to FIG. 17 and thus, further description is omitted.

FIGS. 18A, 18B and 18C illustrate an example of a method of performing a forced conversion in route guidance through a user terminal according to at least one example embodiment.

As described above with reference to FIGS. 10A to 12B, referring to FIGS. 18A, 18B, and 18C, when the distance from the user terminal 100 to a first turn point 1810 (or a point indicator for the first turn point 1810) is greater than the distance from the user terminal 100 to a second turn point 1820 (or a point indicator for the second turn point 1820), a first instruction indicator that instructs a movement to the first turn point 1810 may not be displayed and a second instruction indicator that instructs a movement to the second turn point 1820 may be displayed. Here, when the second turn point 1820 is included in a FOV of the camera of the user terminal 100 or an AR view, a point indicator corresponding to the second turn point 1820 may be displayed.

For example, referring to FIGS. 18A, 18B and 18C, in a case in which the point indicator for the first turn point 1810 indicates the distance to the corresponding first turn point 1810 (i.e., in a case in which the distance between the user terminal 100 and the first turn point 1810 is greater than a predetermined (or alternatively desired) value (e.g., 20 m), if the second turn point 1820 rather than the first turn point 1810 is closer to the user terminal 100 when the user immediately moves to the second turn point 1820 without going through the first turn point 1810 (e.g., by referring to a map view), the first instruction indicator that instructs a movement to the first turn point 1810 may not be displayed and the second instruction indicator that instructs a movement to the second turn point 1820 may be displayed. That is, when the distance from the second turn point 1820 rather than the first turn point 1810 is closer to the user terminal 100, the first instruction indicator that instructs the movement to the first turn point 1810 may be omitted, that is, disappears and the second instruction indicator that instructs the movement to the second turn point 1820 may be displayed. Here, the instruction indicator may direct to the second turn point 1820 (the point indicator for the second turn point 1820). Therefore, a turn point directed to by the instruction indicator may adaptively vary based on the distance between the user terminal 100 and the turn point.

Therefore, when the user inevitably deviates from a route or when the user desires to use another route to more effectively move to a destination (e.g., when the user intentionally skips a movement to the first turn point 1810), route guidance for the destination may be properly provided through the user terminal 100.

Description related to technical features made above with reference to FIGS. 1 to 17 may apply to FIGS. 18A, 18B and 18C and thus, further description is omitted.

According to some example embodiments, there may be provided a route guidance method that may connect the current location of a user and a target location (a turn point) augmented and displayed on an AR view and accordingly, allows the user to maintain a direction of a movement to an augmented destination in a remote distance.

Therefore, according to some example embodiments, a user may not have difficulty in accurately recognizing the direction of a remote augmented indicator. Also, when the user deviates from a target point due to an occurrence of a variable in a movement process, when it is difficult for the user to search for a destination in a wide space and to find the augmented destination, when a boundary between a sidewalk and a road is unclear in a route, and when the user gets lost or misses the next target point due to various variables occurring during a movement, such as an underpass, a crosswalk, street topography, and features, an effective route guidance may be provided. Also, according to some example embodiments, it is possible to minimize an occurrence of an issue in which the user loses the next target location or a destination while moving along a route different from an augmented indicator according to autonomous judgement.

The apparatuses described herein may be implemented using hardware components, software components, and/or a combination thereof. For example, a processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to the example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for their intended purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software. Examples of program instructions include both machine code, such as produced by a compiler, and files containing higher level code that may be executed by the computer using an interpreter.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a source from the disclosure, and all such modifications are intended to be included within the scope of the disclosure.

What is claimed is:

1. A route guidance method performed by a user terminal, comprising:
acquiring a route from a source to a destination set by a user of the user terminal; and
providing route guidance from the source to the destination through an augmented reality (AR) view that includes an image captured by a camera of the user terminal, based on the route,
wherein the route includes at least one turn point, and
the providing of the route guidance comprises, in response to the user terminal moving toward the destination based on the route, selectively displaying on the image a first point indicator that guides to a first turn point approached by the user terminal among the at least one turn point or a first instruction indicator that instructs a movement of the user terminal to the first turn point.

2. The route guidance method of claim 1, wherein each of the at least one turn point is a point at which a turn of a desired angle or more by the user terminal is required on the route, and
the first turn point is a point to which the user terminal is to move from a current location in order to move toward the destination.

3. The route guidance method of claim 1, wherein the displaying of the first point indicator comprises displaying a distance from the user terminal to the first turn point on the first point indicator.

4. The route guidance method of claim 1, wherein the first point indicator is displayed on the image when the first turn point is included in the AR view or a field of view (FOV) of the camera.

5. The route guidance method of claim 1, wherein the first instruction indicator instructs the movement of the user terminal to the first turn point through augmentation on the image without displaying the first point indicator, when the first turn point is not included in the AR view or a FOV of the camera.

6. The route guidance method of claim 5, wherein the first instruction indicator includes a first element that indicates a direction from a current location of the user terminal to the first turn point and a second element that connects from the first element to the first turn point.

7. The route guidance method of claim 6, wherein the first element includes an arrow that indicates the direction from the current location of the user terminal to the first turn point, and
the second element includes a plurality of dots or a line that connects from the first element to the first turn point.

8. The route guidance method of claim 5, wherein the first instruction indicator is displayed to direct to the first turn point according to a rotation of the camera.

9. The route guidance method of claim 5, further comprising:
displaying a map view that includes a map matching the image with the AR view,
wherein the map view includes the route and a current location of the user terminal, and
the first instruction indicator is displayed at a boundary between the map view and the AR view.

10. The route guidance method of claim 5, further comprising displaying the first instruction indicator and a second point indicator that guides to the second turn point or the destination point when the second turn point or the destination point is included in the AR view or the FOV of the camera.

11. The route guidance method of claim 10, wherein the first instruction indicator and the second point indicator are displayed when a distance from the user terminal to the first turn point is less than a distance from the user terminal to the second turn point or the destination point.

12. The route guidance method of claim 1, further comprising changing a display form of the first point indicator when a distance from the user terminal to the first turn point is a desired value or less,
wherein the changed first point indicator includes guidance information about a second turn point to which the user terminal is to move after the first turn point in order to move toward the destination among the at least one turn point or a destination point indicating the destination.

13. The route guidance method of claim 12, further comprising displaying a second instruction indicator that instructs a movement to the second turn point or the destination point through augmentation on the image,
wherein the displaying of the second instruction indicator includes,
displaying the second instruction indicator and the changed first point indicator when the first turn point is included in the AR view or a FOV of the camera; and
displaying the second instruction indicator without displaying the changed first point indicator when the first turn point is not included in the AR view or the FOV of the camera.

14. The route guidance method of claim 13, wherein the second instruction indicator includes an arrow that indicates a direction from a current location of the user terminal to the second turn point or the destination point and a plurality of dots or a line that connects from the arrow to the second turn point or the destination point.

15. The route guidance method of claim 13, wherein the second instruction indicator is displayed when the second turn point or the destination point is not included in the AR view or the FOV of the camera, and
the route guidance method further comprises:
displaying a second point indicator that guides to the second turn point or the destination point without displaying the second instruction indicator when the second turn point or the destination point is included in the AR view or the FOV of the camera.

16. The route guidance method of claim 1, wherein a location at which the first point indicator is displayed in the image is determined based on a location of a vanishing point of the image.

17. The route guidance method of claim 1, wherein the providing of the route guidance comprises searching again for the route to the destination when a location of the user terminal deviates from the route by a predetermined distance or more.

18. A route guidance method performed by a user terminal, comprising:
acquiring a route from a source to a destination set by a user of the user terminal; and
providing route guidance from the source to the destination through an augmented reality (AR) view that includes an image captured by a camera of the user terminal, based on the route,
wherein the route includes at least one turn point, and
the providing of the route guidance comprises:
in response to the user terminal moving toward the destination based on the route, displaying a first instruction indicator that instructs a movement to a first turn point approached by the user terminal among the at least one turn point through augmentation on the image; and
displaying a second instruction indicator that instructs a movement to a second turn point to which the user terminal is to move after the first turn point, without displaying the first instruction indicator, when a distance from the user terminal to the first turn point is a predetermined value or less.

19. A computer system that implements a user terminal, the computer system comprising:
at least one processor configured to execute computer-readable instructions included in a memory,
wherein the at least one processor is configured to acquire a route from a source to a destination set by a user of the user terminal, the route including at least one turn point, and to provide route guidance from the source to the destination through an augmented reality (AR) view that includes an image captured by a camera of the user terminal, based on the route, and to, in response to the user terminal moving toward the destination based on the route, selectively display on the image a first point indicator that guides to a first turn point approached by the user terminal among the at least one turn point or a first instruction indicator that instructs a movement of the user terminal to the first turn point.
